(19) United States
(12) Patent Application Publication
(10) Pub. No.: US 2026/0142520 A1
(43) Pub. Date: May 21, 2026

(54) METHOD FOR MANUFACTURING ROTARY ELECTRIC MACHINE STATOR AND ROTARY ELECTRIC MACHINE STATOR

(71) Applicant: AISIN CORPORATION, Kariya (JP)

(72) Inventors: Yuki KAMIYA, Kariya-shi (JP); Hideaki Kimura, Kariya-shi (JP)

(73) Assignee: AISIN CORPORATION, Kariya (JP)

(21) Appl. No.: 19/366,224

(22) Filed: Oct. 22, 2025

(30) Foreign Application Priority Data
Nov. 19, 2024 (JP) 2024-201719
Aug. 26, 2025 (JP) 2025-140397

(51) Int. Cl. H02K 3/34; H02K 9/19; H02K 15/122; H02K 21/14

(52) U.S. Cl. CPC H02K 3/34; H02K 9/19; H02K 15/122; H02K 21/14

(57) ABSTRACT

A rotary electric machine stator includes: a stator core; a stator coil mounted on the stator core and including coil ends at both ends in an axial direction; and an insulating material portion provided at the coil ends and formed by a foam varnish. The insulating material portion includes, on a surface thereof, an uneven portion caused by foaming.

### CROSS REFERENCE TO RELATED APPLICATIONS

This application is based on and claims priority under 35 U.S.C. § 119 to Japanese Patent Applications 2024-201719, filed on Nov. 19, 2024, and 2025-140397, filed on Aug. 26, 2025, the entire content of which is incorporated herein by reference.

### TECHNICAL FIELD

This disclosure relates to a method for manufacturing a rotary electric machine stator and the rotary electric machine stator.

### BACKGROUND DISCUSSION

In order to fix a stator coil of a rotary electric machine stator, a technique is known in which a resin composition containing a microcapsule foaming agent is applied to a slot liner in advance, the slot liner and a coil wire are inserted into a slot of a stator core, and then the foaming agent is foamed.

Examples of the related art include JP 2020-033433A (Reference 1).

However, the technique in the related art as described above aims to fix the coil wire in the slot, and it is difficult to enhance electrical insulation of a coil end.

Therefore, in one aspect, an object of this disclosure is to effectively enhance electrical insulation of a coil end.

### SUMMARY

According to an aspect of this disclosure, a rotary electric machine stator includes: a stator core; a stator coil mounted on the stator core and including coil ends at both ends in an axial direction; and an insulating material portion provided at the coil ends and formed by a foam varnish. The insulating material portion includes, on a surface thereof, an uneven portion caused by foaming.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a cross-sectional view schematically illustrating a cross-sectional structure of a motor according to an embodiment;

FIG. 2 is a plan view of a stator core alone;

FIG. 3 is a diagram schematically illustrating a pair of coil pieces assembled to the stator core;

FIG. 4 is a schematic front view of one of the coil pieces;

FIG. 5 is a cross-sectional view taken along a line V-V in FIG. 4;

FIG. 6 is a cross-sectional view schematically illustrating an insulating material portion provided at a coil end according to the present embodiment;

FIG. 7 is a diagram illustrating a cross section of a portion of the insulating material portion located between two adjacent crossover portions;

FIG. 8 is a diagram (part 1) illustrating a location suitable for forming a first portion and a second portion;

FIG. 9 is a diagram (part 2) illustrating a location suitable for forming the first portion and the second portion;

FIG. 10 is a diagram illustrating test results of a partial discharge inception voltage; and

FIG. 11 is a schematic flowchart of a main part of a stator manufacturing method according to the present embodiment.

### DETAILED DESCRIPTION

Hereinafter, embodiments will be described in detail with reference to the accompanying drawings. Dimensional ratios in the drawings are merely examples and are not limited thereto. Further, shapes and the like in the drawings may be partially exaggerated for the convenience of description. In the drawings, for the sake of clarity, a plurality of parts having the same attribute may be only partially denoted by reference numerals.

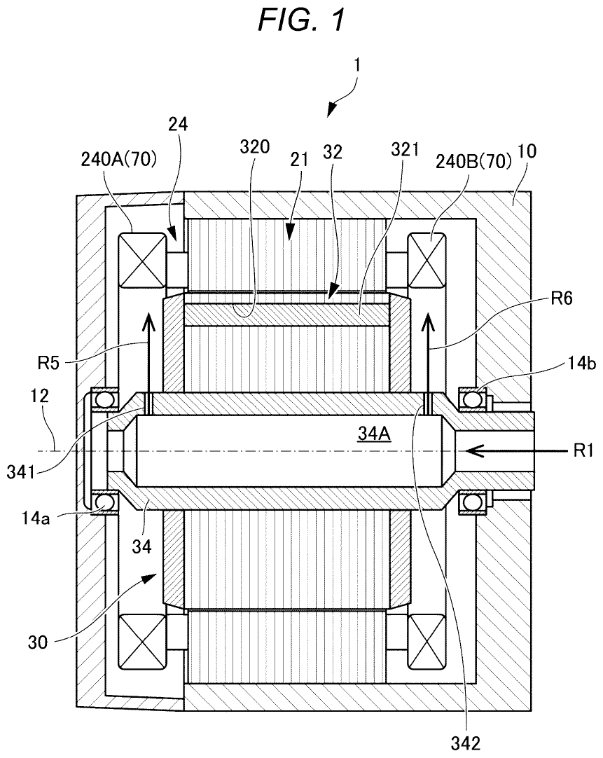

FIG. 1 is a cross-sectional view schematically illustrating a cross-sectional structure of a motor 1 according to an embodiment.

FIG. 1 illustrates a rotation axis 12 of the motor 1. In the following description, an axial direction refers to a direction in which the rotation axis (rotation center) 12 of the motor 1 extends, and a radial direction refers to a radial direction around the rotation axis 12. Therefore, a radially outer side refers to a side away from the rotation axis 12, and a radially inner side refers to a side toward the rotation axis 12. A circumferential direction corresponds to a rotation direction around the rotation axis 12.

The motor 1 may be, for example, a vehicle driving motor used in a hybrid vehicle or an electric vehicle. Alternatively, the motor 1 may be used for any other application.

The motor 1 is of an inner rotor type, and a stator 21 is provided to surround a radially outer side of a rotor 30. A radially outer side of the stator 21 is fixed to a motor housing 10.

The rotor 30 is disposed on a radially inner side of the stator 21. The rotor 30 includes a rotor core 32 and a rotor shaft 34. The rotor core 32 is fixed to a radially outer side of the rotor shaft 34 and rotates integrally with the rotor shaft 34. The rotor shaft 34 is rotatably supported by the motor housing 10 via bearings 14a and 14b. The rotor shaft 34 defines the rotation axis 12 of the motor 1.

The rotor core 32 is formed of, for example, annular magnetic laminated steel plates. A permanent magnet 321 is inserted into a magnet hole 320 of the rotor core 32. The number, arrangement, and the like of the permanent magnet 321 are freely set. In a modification, the rotor core 32 may be formed of a green compact obtained by compressing and solidifying magnetic powder.

As illustrated in FIG. 1, the rotor shaft 34 has a hollow portion 34A. The hollow portion 34A extends over an entire length of the rotor shaft 34 in the axial direction. The hollow portion 34A may function as an oil passage. For example, as indicated by an arrow R1 in FIG. 1, oil is supplied to the hollow portion 34A from one end side in the axial direction, and the oil flows along a surface of the rotor shaft 34 on the radially inner side, so that the rotor core 32 can be cooled from the radially inner side. Further, the oil flowing along the surface of the rotor shaft 34 on the radially inner side may be ejected toward the radially outer side through oil holes 341 and 342 formed at both end portions of the rotor shaft 34 (arrows R5 and R6), and used for cooling coil ends 240A and 240B.

Although FIG. 1 illustrates the motor 1 having a specific structure, the structure of the motor 1 is freely set as long as the motor 1 has a stator coil 24 (described later) joined by welding. Therefore, for example, the rotor shaft 34 may not include the hollow portion 34A, or may include a hollow portion having a significantly smaller inner diameter than that of the hollow portion 34A. In FIG. 1, a specific cooling method is disclosed, but the cooling method of the motor 1 is freely set. For example, an oil introduction pipe inserted into the hollow portion 34A may be provided, or oil may be dropped from an oil passage in the motor housing 10 toward the coil ends 240A and 240B from the radially outer side.

In FIG. 1, the motor 1 is the inner rotor type motor in which the rotor 30 is disposed inside the stator 21, but a motor of another form may be applied. For example, the present disclosure may be applied to an outer rotor type motor in which the rotor 30 is concentrically disposed outside the stator 21 or a dual rotor type motor in which the rotors 30 are disposed outside and inside the stator 21. The oil (oil for cooling the motor 1) may be supplied to the motor housing 10 in any manner, and may be supplied using an electric oil pump, a mechanical oil pump, gear lifting, or the like.

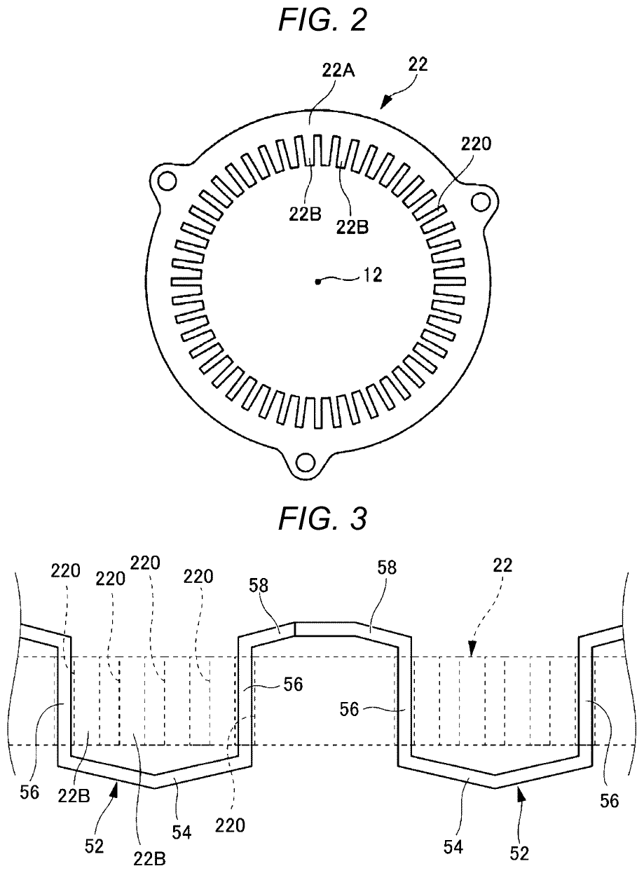

Next, a configuration of the stator 21 will be described in detail with reference to FIG. 2 and subsequent drawings.

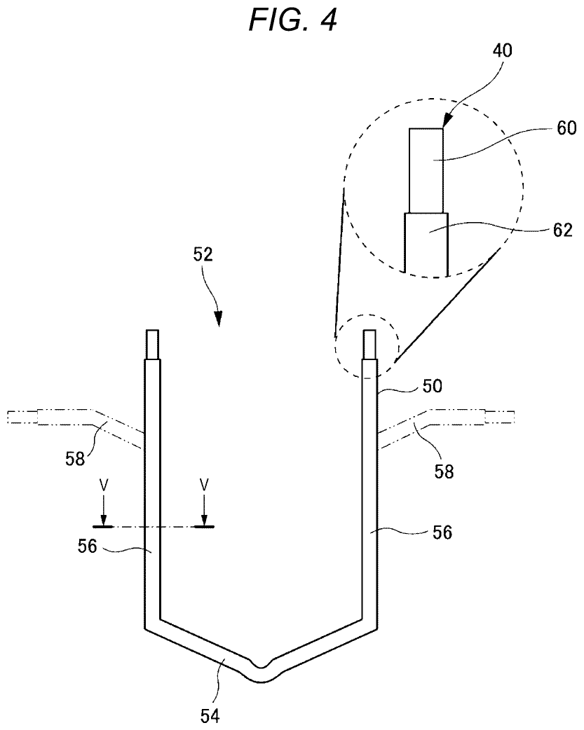

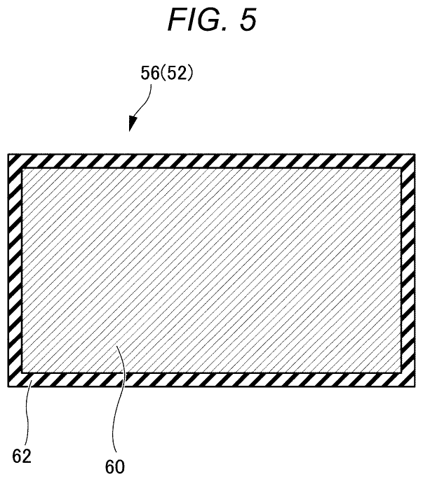

FIG. 2 is a plan view of a stator core 22 alone. FIG. 3 is a diagram schematically illustrating a pair of coil pieces 52 assembled to the stator core 22. FIG. 4 is a schematic front view of one of the coil pieces 52. FIG. 5 is a cross-sectional view taken along a line V-V in FIG. 4, and is a cross-sectional view at a slot insertion portion 56. FIG. 3 illustrates a relationship between the pair of coil pieces 52 and slots 220 in a state where a radially inner side of the stator core 22 is developed. In FIG. 3, the stator core 22 is indicated by a dotted line, and some of the slots 220 are not illustrated.

The stator 21 includes the stator core 22 and the stator coil 24 (see FIG. 1).

The stator core 22 is formed of, for example, annular magnetic laminated steel plates, but in a modification, the stator core 22 may be formed of a green compact obtained by compressing and solidifying magnetic powder. The stator core 22 may be formed by divided cores that are divided in the circumferential direction, or may not be divided in the circumferential direction. A plurality of slots 220 around which the stator coil 24 is wound are formed on the radially inner side of the stator core 22. Specifically, as illustrated in FIG. 2, the stator core 22 includes an annular back yoke 22A and a plurality of teeth 22B extending toward the radially inner side from the back yoke 22A, and the slots 220 are formed between the plurality of teeth 22B in the circumferential direction. The number of slots 220 is freely set, but is 48 as an example in the present embodiment.

As the stator coil 24, the stator coils 24 of a U phase, a V phase, and a W phase are formed. A base end of the stator coil 24 of each phase is connected to an input terminal (not illustrated), and an end of the stator coil 24 of each phase is connected to an end of the stator coil 24 of another phase to form a neutral point of the motor 1. That is, the stator coils 24 are star-connected. However, a connection mode of the stator coils 24 may be appropriately changed according to required motor characteristics and the like, and for example, the stator coil 24 may be delta-connected instead of being star-connected.

The stator coil 24 of each phase is formed by joining a plurality of coil pieces 52. The coil piece 52 is in a form of a segment coil obtained by dividing the stator coil 24 of each phase into units easy to assemble (for example, units inserted into two slots 220). As illustrated in FIG. 5, the coil piece 52 is formed by coating a linear conductor (flat wire) 60 having a rectangular cross section with an insulating film 62. In the present embodiment, the linear conductor 60 is made of, for example, copper. However, in a modification, the linear conductor 60 may be made of another conductor material such as iron or aluminum. The cross-sectional shape of the linear conductor 60 may be other than a rectangle.

Before being assembled to the stator core 22, the coil piece 52 may be formed in a substantially U shape having a pair of straight portions 50 and a coupling portion 54 coupling the pair of straight portions 50. When the coil piece 52 is assembled to the stator core 22, the pair of straight portions 50 are inserted into the slots 220 (see FIG. 3), respectively. Accordingly, as illustrated in FIG. 3, the coupling portion 54 extends in the circumferential direction so as to straddle the plurality of teeth 22B (and the plurality of slots 220 accordingly) on the other end side of the stator core 22 in the axial direction. The number of slots 220 straddled by the coupling portion 54 is freely set, but is three in FIG. 3. After the straight portions 50 are inserted into the slots 220, the straight portions 50 are bent in the circumferential direction in the middle thereof as indicated by two-dot chain lines in FIG. 4. Accordingly, the straight portion 50 includes the slot insertion portion 56 extending in the axial direction in the slot 220 and a crossover portion 58 extending in the circumferential direction on one end side of the stator core 22 in the axial direction. In this case, the coupling portion 54 forms one of the coil ends 240A and 240B, and the crossover portion 58 forms the other of the coil ends 240A and 240B.

In FIG. 4, the pair of straight portions 50 are bent in directions away from each other, but the present disclosure is not limited thereto. For example, the pair of straight portions 50 may be bent in directions approaching each other. The stator coil 24 may also include a neutral point coil piece or the like for forming a neutral point by coupling the ends of the stator coils 24 of the respective phases.

A plurality of slot insertion portions 56 of the coil piece 52 illustrated in FIG. 4 are inserted into one slot 220 side by side in the radial direction. Therefore, a plurality of crossover portions 58 extending in the circumferential direction are arranged in the radial direction on the one end side of the stator core 22 in the axial direction. As illustrated in FIG. 3, the crossover portion 58 of one coil piece 52 protruding from one slot 220 and extending to a first side in the circumferential direction (for example, clockwise direction) is joined to the crossover portion 58 of another coil piece 52 protruding from another slot 220 and extending to a second side in the circumferential direction (for example, counterclockwise direction) at joining portions 40 (see FIG. 4).

In the present embodiment, as an example, the coil piece 52 including two slot insertion portions 56 is used, but a coil piece in another form such as a coil piece including four or more slot insertion portions 56 is also applicable.

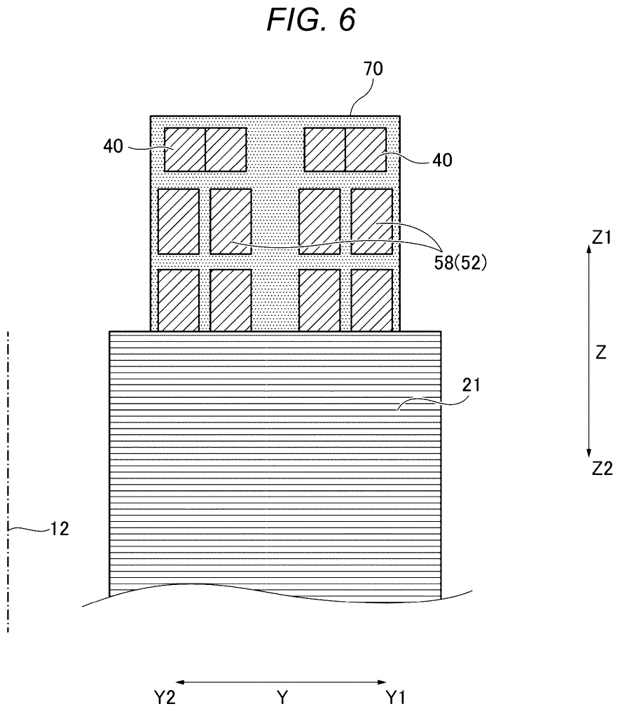

Next, a characteristic configuration according to the present embodiment will be described with reference to FIG. 6.

FIG. 6 is a cross-sectional view schematically illustrating an insulating material portion 70 provided at the coil end 240A according to the present embodiment. In FIG. 6, only one side of a cross section that is rotationally symmetric with respect to the rotation axis 12 is illustrated. In FIG. 6, a Z direction is the axial direction, and a Z1 side is an axially outer side. A Y direction is the radial direction, and a Y1 side is the radially outer side. Although the insulating material portion 70 provided at the coil end 240A will be mainly described below, a similar insulating material portion may be provided at the coil end 240B.

The insulating material portion 70 is provided at the coil end 240A according to the present embodiment. The insulating material portion 70 is formed by a foam varnish. A material of the foam varnish is freely set, but may be, for example, a resin material containing a foam body, and in this case, the foam body is foamed in a mode in which an uneven portion caused by foaming is formed on a surface of the resin material.

The insulating material portion 70 may be provided to cover the entire coil end 240A. That is, the insulating material portion 70 may be provided such that any coil piece 52 forming the coil end 240A is not exposed.

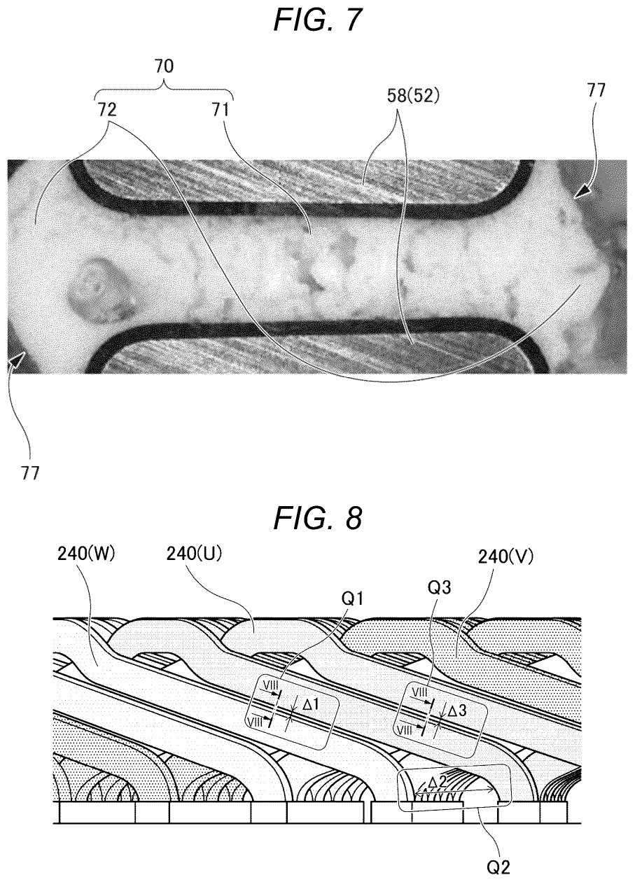

FIG. 7 is a diagram illustrating a cross section of a portion of the insulating material portion 70 located between two adjacent crossover portions 58. The two adjacent crossover portions 58 are the crossover portions 58 of the two coil pieces 52 forming the coil end 240A.

As illustrated in FIG. 7, the insulating material portion 70 according to the present embodiment includes, on a surface thereof, an uneven portion 77 caused by foaming. The uneven portion 77 is basically formed over the entire surface. As described above with reference to FIG. 1, in the present embodiment, the cooling oil for cooling the motor is supplied to the coil end 240A. When the oil is supplied to the insulating material portion 70 of the coil end 240A, the oil enters the uneven portion 77 of the insulating material portion 70 and is easily held by the uneven portion 77. In addition, the oil easily permeates into gaps (voids) inside the insulating material portion 70.

In the present embodiment, the insulating material portion 70 has a first portion 71 and a second portion 72 at the coil end 240A.

The first portion 71 is formed in a gap between two adjacent crossover portions 58. The first portion 71 can be formed by causing the foam varnish to enter (impregnate) the gap between the two adjacent crossover portions 58 and foaming the foam body.

The second portion 72 is continuous from the first portion 71 and protrudes in a convex shape from between two adjacent crossover portions 58. The second portion 72 can be formed by causing a sufficient amount of foam varnish to enter the gap between the two adjacent crossover portions 58 and foaming the foam body. That is, when a sufficient amount of foam varnish enters the gap to foam the foam body, the foam body expands to a volume equal to or larger than a volume of the gap, and the second portion 72 is formed.

Since the second portion 72 is a portion protruding in a convex shape from the gap between the two adjacent crossover portions 58, the oil is easily supplied directly to a surface of the second portion 72. For example, during an operation of the motor 1, basically, the oil is always supplied to the surface of the second portion 72. Therefore, the second portion 72 can basically always retain the oil during the operation of the motor 1.

The first portion 71 and the second portion 72 as described above can be formed in the gap between the crossover portions 58 of the coil end 240A.

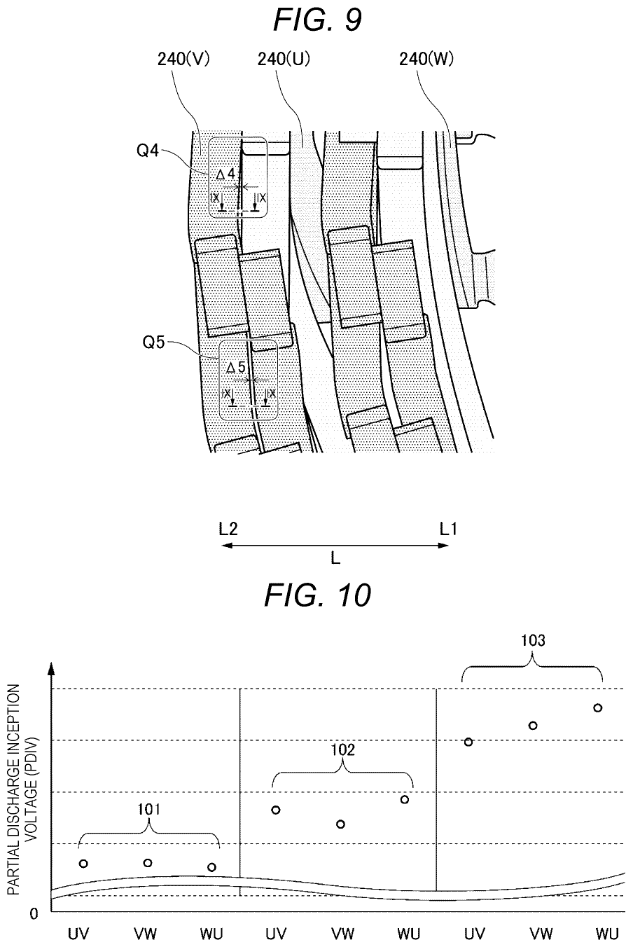

FIG. 8 and FIG. 9 are diagrams illustrating suitable locations for forming the first portion 71 and the second portion 72. In FIGS. 8 and 9, illustration of the insulating material portion 70 is omitted for the sake of clarity.

In the following description, the coil end 240 of one phase refers to a coil end portion formed by the one phase among the coil ends 240A formed by the stator coils 24 of three phases.

FIGS. 8 and 9 are diagrams illustrating a positional relationship of the stator coils 24 of respective phases in the coil end 240A, FIG. 8 illustrates a part of the coil ends 240A in a side view (view viewed perpendicularly to the axial direction), and FIG. 9 illustrates a part of the coil ends 240A in a top view (view viewed in the axial direction). In FIGS. 8 and 9, for ease of understanding, the coil ends 240 of phases are hatched differently for respective phases, a U phase coil end 240 is denoted by reference numeral 240 (U), a V phase coil end 240 is denoted by reference numeral 240 (V), and a W phase coil end 240 is denoted by reference numeral 240 (W). In FIG. 9, an L direction parallel to the radial direction is defined, an L1 side corresponds to the radially inner side, and an L2 side corresponds to the radially outer side.

In the present embodiment, the insulating material portion 70 is formed over the entire coil end 240A including the gap between two adjacent crossover portions 58. Therefore, the insulating material portion 70 is also formed in gaps Δ1 to Δ3 at locations Q1 to Q3 illustrated in FIG. 8. In the insulating material portion 70 formed at the locations Q1 and Q2, a cross section along a line VIII-VIII illustrated in FIG. 8 may be similar to the cross section illustrated in FIG. 7. The locations Q1 and Q2 include the gaps Δ1 and Δ2 between surfaces (surfaces of two adjacent crossover portions 58) where different phases face each other in the axial direction, and the location Q3 includes the gap Δ3 between surfaces (surfaces of two adjacent crossover portions 58) where the same phases face each other in the axial direction.

Similarly, the insulating material portion 70 is also formed in gaps Δ4 and Δ5 at locations Q4 and Q5 illustrated in FIG. 9. The location Q4 includes the gap Δ4 between surfaces (surfaces of two adjacent crossover portions 58) where different phases face each other in the radial direction, and the location Q5 includes the gap Δ5 between surfaces (surfaces of two adjacent crossover portions 58) where the same phases face each other in the radial direction. In the insulating material portion 70 formed at the locations Q4 and Q5, a cross section along a line IX-IX illustrated in FIG. 9 may be similar to the cross section illustrated in FIG. 7.

FIG. 10 is a diagram illustrating test results of a partial discharge inception voltage (PDIV). FIG. 10 illustrates a test result 101 in a state before application of the foam varnish, a test result 102 in a state after application and foaming of the foam varnish, and a test result 103 according to the present embodiment. The test result 103 according to the present embodiment corresponds to a test result in the state after application and foaming of the foam varnish and in a state in which the oil is applied to the foam varnish. A vertical axis indicates the partial discharge inception voltage, characters “UV” on a horizontal axis indicate the partial discharge inception voltage between the U phase and the V phase, characters “VW” indicate the partial discharge inception voltage between the V phase and the W phase, and the same applies below

As can be seen from FIG. 10 by comparing the test result 103 with the other test results 101 and 102, according to the present embodiment, the partial discharge inception voltage can be significantly increased. In particular, it is a new finding that the partial discharge inception voltage can be significantly increased in the state in which the oil is applied to the foam varnish (insulating material portion 70) as compared with a state in which the oil is not applied (test result 102). In the present embodiment, it can be presumed that such an effect is enhanced by the insulating material portion 70 having unevenness on the surface. The oil applied to the foam varnish (insulating material portion 70) may have the same component as the oil for cooling the motor 1.

In this manner, according to the present embodiment, in the coil end 240A, electrical insulation between different phases can be effectively enhanced (that is, the partial discharge inception voltage can be effectively increased).

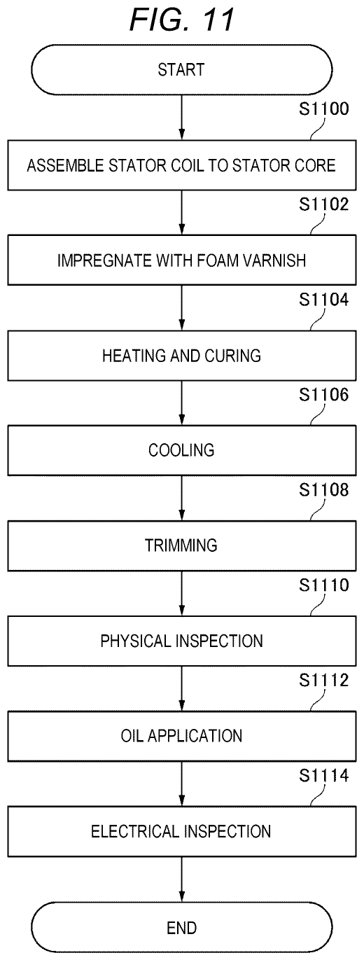

Next, a method for manufacturing the stator 21 according to the present embodiment will be described with reference to FIG. 11.

FIG. 11 is a schematic flowchart of a main part of the method for manufacturing the stator 21 according to the present embodiment.

The present manufacturing method includes a step (step S1100) of mounting the stator coil 24 on the stator core 22 and forming an assembly (not illustrated) including the coil ends 240A and 240B at both ends in the axial direction.

Next, the present manufacturing method includes a step of impregnating the coil ends 240A and 240B with the foam varnish (step S1102). This step may be implemented by dropping the foam varnish onto the coil ends 240A and 240B, or may be implemented by immersing the coil ends 240A and 240B in a tank containing the foam varnish.

Next, the present manufacturing method includes a step of heating and curing the foam varnish with which the coil ends 240A and 240B are impregnated (step S1104). In this step, the foam varnish is foamed to form the insulating material portion 70. That is, the insulating material portion 70 including an uneven portion on the surface (particularly, the surface of the second portion 72) is formed.

Next, the present manufacturing method includes subsequent steps such as a cooling step (step S1106), a trimming step (step S1108), and a physical inspection step (step S1110), and then an oil application step (step S1112). The oil application step includes applying oil to the coil ends 240A and 240B to hold the oil in the insulating material portion 70. An oil application method may be freely set, such as dropping or immersion.

Next, the present manufacturing method includes an electrical inspection step (step S1114). The electrical inspection step may include a step of inspecting whether necessary electrical insulation is secured in the coil ends 240A and 240B. For example, the electrical inspection step may include a step of inspecting whether a measured value of the partial discharge inception voltage exceeds a reference value.

When it is confirmed in the electrical inspection step (step S1114) that the necessary electrical insulation is secured, the stator 21 is completed, and the stator 21 is sent to a shipping step (or an assembling step for a transmission or the like).

According to the present manufacturing method, the stator 21 in which the electrical insulation of the coil ends 240A and 240B is effectively enhanced can be manufactured.

According to an aspect of this disclosure, a rotary electric machine stator includes: a stator core; a stator coil mounted on the stator core and including coil ends at both ends in an axial direction; and an insulating material portion provided at the coil ends and formed by a foam varnish. The insulating material portion includes, on a surface thereof, an uneven portion caused by foaming.

In one aspect, according to the present disclosure, electrical insulation of the coil ends can be effectively enhanced.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A rotary electric machine stator, comprising:
a stator core;
a stator coil mounted on the stator core and including coil ends at both ends in an axial direction; and
an insulating material portion provided at the coil ends and formed by a foam varnish, wherein
the insulating material portion includes, on a surface thereof, an uneven portion caused by foaming.

2. The rotary electric machine stator according to claim 1, wherein
the insulating material portion has, at each of the coil ends, a first portion formed in a gap between coil wires related to the stator coil and a second portion continuous from the first portion and protruding in a convex shape from between the coil wires.

3. The rotary electric machine stator according to claim 1, wherein
the insulating material portion holds oil for cooling a rotary electric machine in the uneven portion.

4. The rotary electric machine stator according to claim 2, wherein
the insulating material portion holds oil for cooling a rotary electric machine in the uneven portion.

5. A method for manufacturing a rotary electric machine stator, comprising:
a mounting step of mounting a stator coil on a stator core and forming an assembly including coil ends at both ends in an axial direction;
a forming step of forming an insulating material portion at the coil ends by applying a foam varnish to the coil ends and foaming the foam varnish, after the mounting step; and
a step of applying oil to the insulating material portion after the forming step, wherein the forming step includes causing an uneven portion caused by foaming to be generated on a surface of the insulating material portion.

6. A rotary electric machine comprising:
a case forming an accommodation space containing oil for cooling the rotary electric machine; and
a rotor and a stator accommodated in the case, wherein
the stator includes
a stator core,
a stator coil mounted on the stator core and including coil ends at both ends in an axial direction, and
an insulating material portion provided at the coil ends and formed by a foam varnish, and
the insulating material portion includes, on a surface thereof, an uneven portion that is an uneven portion caused by foaming and that holds the oil.
